(19) United States
(12) Patent Application Publication
(10) Pub. No.: US 2008/0299387 A1
(43) Pub. Date: Dec. 4, 2008

(54) Bonded Plate for Sink Bowl and Method of Forming the Sink Bowl Using the Same Through Pressing

(75) Inventors: Hae-sik Lee, Gwangju (KR); Bong-jun Lee, Gwangju (KR)

Correspondence Address: QUINN LAW GROUP, PLLC, 39555 ORCHARD HILL PLACE, SUITE # 520, NOVI, MI, 48375, US

(73) Assignees: MATERIAL SCIENCES CORPORATION, Elk Grove Village, IL (US); HAEWON MSC CO., LTD, Jeollanam-do (KR)

(21) Appl. No.: 12/130,109

(22) Filed: May 30, 2008

(30) Foreign Application Priority Data
May 31, 2007 (KR) 10-2007-0053531

(51) Int. Cl. B32B 17/10; B32B 37/00

(52) U.S. Cl. 428/339; 156/267

(57) ABSTRACT

A bonded plate for a sink bowl, which has excellent sound-absorbing, vibration-damping, and heat-insulating characteristics, and a method of forming the sink bowl using the same through pressing. The bonded plate includes a surface plate, a backing plate backing the surface plate, and an adhesive resin interposed between the surface plate and the backing plate and bonding the surface plate and the backing plate with each other, wherein the adhesive resin has a thickness from about 0.02 mm to about 0.1 mm. Thereby, the adhesive resin layer of the bonded plate can have sound-absorbing, vibration-damping, and dew-condensation-preventing functions. Further, the sink bowl is produced using the bonded plate, so that it can reduce the cost of production, can provide formability equal to that of the conventional sink bowl, and can produce excellent sound-absorbing, vibration-damping, and dew-condensation-preventing effects.

### CROSS-REFERENCE TO RELATED APPLICATIONS

This application claims priority to Republic of Korea Patent Application 10-2007-0053531, filed on May 31, 2007.

### TECHNICAL FIELD

The present invention relates to a bonded steel plate for a sink bowl, which has excellent sound-absorbing, vibration-damping and heat-insulating characteristics, and a method of press-forming a sink bowl using the same bonded steel plate.

### BACKGROUND OF THE INVENTION

In general, steel sheets themselves have very poor sound-isolating, sound-absorbing, vibration-damping and heat-insulating characteristics, and have limitations of wide application to products, particularly, exposed to noise, vibration, change in temperature, and so on. For this reason, conventionally, the steel sheets make up for such characteristics by interposing a sound absorbing material and a material having excellent vibration-damping characteristics (e.g. vibration damping sheet, paint, tape and the like) between two of them.

However, in the case of using the sound absorbing material, etc. in this way, the sound absorbing material, etc. should be separately installed when constructed, and particularly, in terms of the workability, the sound absorbing material, etc. should be separately worked so as to be compatible with the shape of each steel sheet apart from steel sheet working.

Especially, in the case of producing a sink bowl using a steel sheet (e.g. a stainless steel sheet), the sink bowl has an advantage in that it is not cracked or fractured because the steel sheet itself has high strength. However, the sink bowl has a disadvantage in that, during washing-up, it collides with metal tableware causing offensive noise as well as vibration propagating along the same. Furthermore, the sink bowl causes dew condensation by a temperature difference between inner and outer surfaces thereof because the heat insulating characteristics of the steel sheet are poor. Thus, conventionally, the dew condensation is prevented by attaching a ball cover, which is capable of covering the outer surface of the sink bowl to insulate heat. Further, in order to block the noise and vibration, a method of attaching a member such as an aluminum pad to the outer surface of the sink bowl is employed. However, in the case of producing the entire sink bowl using only the steel sheet (e.g. SUS 304), the sink bowl increases the cost burden of the steel sheet. Further, the separate subsidiary materials such as the ball cover and the aluminum pad cause the sink bowl to incur additional cost. Furthermore, in terms of the production process, a process of installing the subsidiary materials is additionally required to increase the cost of production.

### SUMMARY OF THE INVENTION

Accordingly, the present invention provides a bonded steel sheet, which can be applied to the products such as the sink bowl requiring excellent sound-absorbing and vibration-damping characteristics, removing the need to attach the separate subsidiary materials due to its own sound-absorbing, vibration-damping, and dew-condensation-preventing characteristics, and be wrought in various shapes due to excellent workability (e.g. pressing).

The present invention has been made keeping in mind the above problems occurring in the prior art, and an object of the present invention is to provide a bonded plate, which bonds a surface plate with a backing plate using the adhesive resin, thereby allowing a layer of the adhesive resin thereof to have sound-absorbing, vibration-damping, and dew-condensation-preventing functions, and which is used to produce a sink bowl, thereby reducing the cost of production, providing formability equal to that of a conventional sink bowl, and producing excellent sound-absorbing, vibration-damping and dew-condensation-preventing effects of the sink bowl.

Another object of the present invention is to provide a bonded plate, which has an adhesive resin maintaining a predetermined viscosity, thereby preventing an adhesive resin layer itself from being fractured, and increasing sound-absorbing, vibration-damping and heat-insulating characteristics due to such viscosity.

Meanwhile, in order to solve the problem that the cost of production is sharply increased in the case of using a conventional single steel sheet made of relatively expensive stainless steel, etc., an object of the present invention is to provide a bonded plate, in which a surface plate exposed to the outside is formed thin using a steel sheet having excellent corrosion resistance and workability, and simultaneously a backing plate backing the surface plate inside is formed of a relatively inexpensive steel sheet and is bonded with the surface plate using an adhesive resin having excellent sound-absorbing, vibration-damping, and heat-insulating characteristics, thereby remarkably reducing the cost of production.

According to an aspect of the present invention, there is provided a bonded plate for a sink bowl, having excellent sound-absorbing, vibration-damping, and heat-insulating characteristics. The bonded plate includes: a surface plate; a backing plate backing the surface plate; and an adhesive resin interposed between the surface plate and the backing plate and bonding the surface plate and the backing plate with each other, wherein the adhesive resin has a thickness from about 0.02 mm to about 0.1 mm.

Here, the surface plate may have a thickness from about 0.1 mm to about 0.4 mm, and the backing plate may have a thickness from about 0.4 mm to about 1.2 mm.

Further, the surface plate may be formed of stainless steel, which has excellent corrosion resistance and workability, and the backing plate may be formed from any one selected from a galvanized steel sheet, a stainless steel sheet, an aluminum sheet, a polyester painted steel sheet, a cold rolled steel sheet, and a pickled and oiled steel sheet.

Also, the surface plate and the backing plate may each have bending rigidity from about 10.5 Nm to about 16.5 Nm.

Meanwhile, the backing plate may further include an anti-corrosion coating layer on a lower surface thereof.

Further, the adhesive resin may have viscosity from about 2500 cps to about 4500 cps.

According to another aspect of the present invention, there is provided a method of forming a sink bowl using a bonded plate having excellent sound-absorbing, vibration-damping, and heat-insulating characteristics through multi-stage pressing. The method includes the steps of: preparing the bonded plate by bonding a surface plate and a backing plate with an adhesive resin having viscosity from 2500 cps to 4500 cps; modeling the sink bowl in a desired shape by sequentially pressing the bonded plate using a first die capable of pressing the modeled sink bowl up to a depth between ½ and ⅔ from the top of the sink bowl and a second die capable of pressing the pressed sink bowl up to a bottom of the modeled sink bowl; and cutting off surrounding unnecessary portions of the pressed sink bowl using a trimming die.

Here, the bonded plate may include the surface plate, the backing plate backing the surface plate, and the adhesive resin interposed between the surface plate and the backing plate and bonding the surface plate and the backing plate with each other; the adhesive resin may have a thickness from about 0.02 mm to about 0.1 mm; the surface plate may have a thickness from about 0.1 mm to about 0.4 mm; and the backing plate may have a thickness from about 0.4 mm to about 1.2 mm.

Further, the surface plate may be formed of stainless steel, which has excellent corrosion resistance and workability; the backing plate may be formed from any one selected from a galvanized steel sheet, a stainless steel sheet, an aluminum sheet, a polyester painted steel sheet, a cold rolled steel sheet, and a pickled and oiled steel sheet; and the surface plate and the backing plate may each have bending rigidity from about 10.5 Nm to about 16.5 Nm.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a partial perspective view illustrating the structure of a bonded plate according to an embodiment of the present invention;

FIG. 2 is a sectional view taken along the line A-A of FIG. 1;

FIG. 3 is a perspective view illustrating a sink bowl produced using a bonded plate according to the present invention; and

FIG. 4 is a conceptual view taken illustrating a method of forming a sink bowl using a bonded plate through pressing according to another embodiment of the present invention.

### DESCRIPTION OF THE PREFERRED EMBODIMENTS

Hereinafter, a bonded plate and a sink bowl using the same, according to the present invention, will be described in greater detail with reference to the accompanying drawings.

### Structure of Bonded Plate

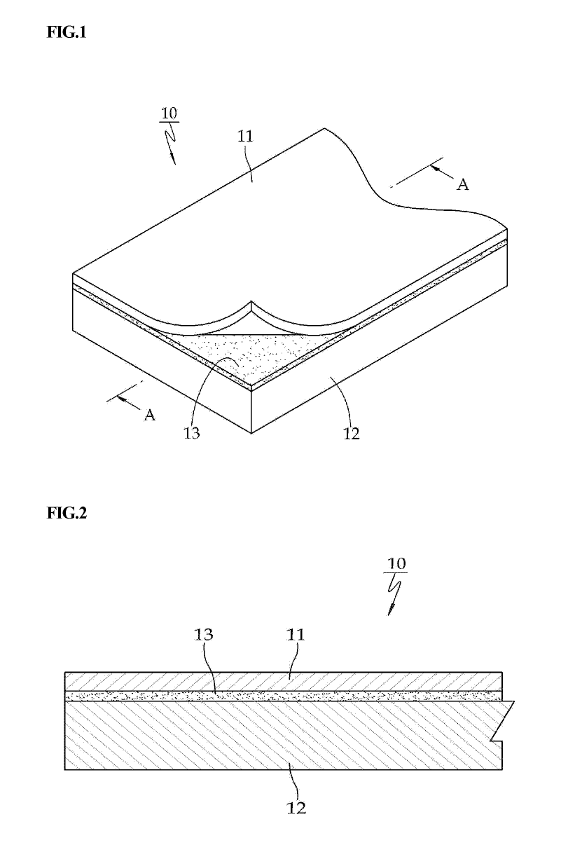

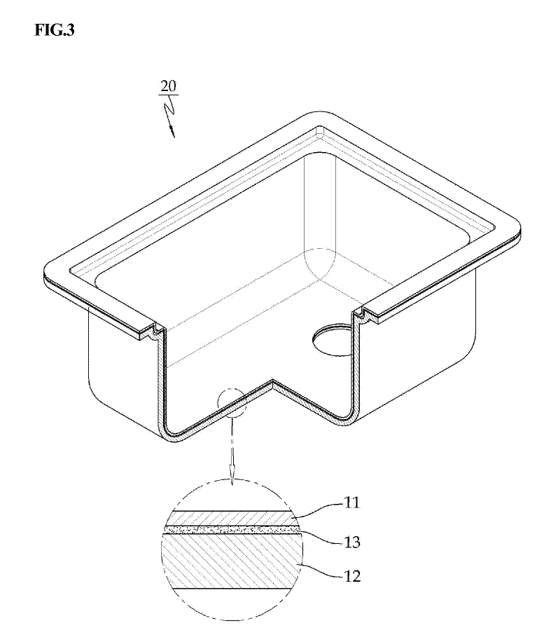

FIG. 1 is a partial perspective view illustrating the structure of a bonded plate according to an embodiment of the present invention, and FIG. 2 is a sectional view taken along the line A-A of FIG. 1.

As illustrated in FIGS. 1 and 2, the bonded plate 10 according to the present invention includes a surface plate 11, a backing plate 12 backing the surface plate 11, and an adhesive resin 13 interposed between the surface plate 11 and the backing plate 12 to bond the surface and backing plates 11 and 12 with each other.

Preferably, the surface plate 11 is made of stainless steel, which has excellent workability and corrosion resistance, and the backing plate 12 is selected from a galvanized steel sheet, a stainless steel sheet, an aluminum sheet, a polyester painted steel sheet, a cold rolled steel sheet, or a pickled and oiled steel sheet. More preferably, the surface plate 11 employs any one of the SUS 300 series having excellent workability and corrosion resistance (and most preferably SUS 304). The surface plate 11 is essential to have the corrosion resistance for preventing rust from being generated, because the sink bowl by nature is always exposed to moisture and chemical components (e.g. a detergent). Further, it is apparent that the bonded plate 10 should make use of a material having excellent formability, because the sink bowl should be formed using the bonded plate 10 according to the present invention.

Meanwhile, the backing plate 12 is preferably selected from the steel sheets, which have excellent workability in order to secure the formability of the entire bonded plate 11 so as to bend the bonded plate 10 as well as enough strength to back the surface plate 11. Specifically, the backing plate 12 can employ a galvanized steel sheet, a stainless steel sheet, an aluminum sheet, a polyester painted steel sheet, a cold rolled steel sheet, or a pickled and oiled steel sheet. Here, the galvanized steel sheet should be broadly interpreted to include a hot dip galvanized steel sheet, an electrolytic galvanized steel sheet, a galvannealed steel sheet, an aluminum coated steel sheet, a zinc-aluminum alloy coated steel sheet and so on.

As described above, the surface plate 11 and the backing plate 12 should have excellent formability in order to form the bonded plate 10 into products having various shapes. In order to meet this formability, the bonded plate is preferably selected from materials having bending rigidity from 10.5 Nm to 16.5 Nm.

The bending rigidity is calculated using a Ross Kerwin Ungar (RKU) method expressed by Equation 1 below:

$$E = \frac{12 ( 1 - {υ}^{2} ) {B}_{c}}{{t}_{c}^{3}} , \qquad Equation 1$$

where B_{c} is the bending rigidity, υ is the Poisson's ratio, and t_{c} is the total thickness.

Particularly, when the bending rigidity is less than 10.5 Nm, the bonded plate 10 is warped by weak force, and thus can be vulnerable to external impact after formation. In contrast, when the bending rigidity is more than 16.5 Nm, the bonded plate 10 has reduced formability, and thus cannot be smoothly formed into the products such as the sink bowl.

The adhesive resin 13 is interposed between the surface plate 11 and the backing plate 12, and functions to bond the surface and backing plate 11 and 12 with each other. Preferably, the adhesive resin 13 is formed at a thickness from 0.02 mm to 0.1 mm. Because the adhesive resin 13 is interposed between the surface and backing plates 11 and 12 to serve as a shock-absorbing and heat-insulating material, it enables the entire bonded plate 10 to produce excellent sound-absorbing, heat-insulating, and vibration-damping effects. In other words, a layer of the adhesive resin 13 functions to bond the surface plate 11 and the backing plate 12, and simultaneously damp the vibration and noise applied from the outside. Furthermore, the adhesive resin layer serves as the heat-insulating material, and thus inhibits dew condensation from being generated from the sink bowl.

Preferably, the adhesive resin used in the present invention has viscosity from 2500 cps to 4500 cps. When the viscosity is less than 2500 cps, the viscosity of the adhesive resin is too low, so that the adhesive resin cannot firmly bond the surface plate and the backing plate. In contrast, when the viscosity is more than 4500 cps, the viscosity of the adhesive resin is too high, so that, in the case of forming and working the bonded plate, part of the cured adhesive resin layer is fractured, or the surface plate of the bonded plate is warped. Thus, the adhesive resin used for the bonded plate of the present invention should maintain the viscosity of a predetermined level in order to guarantee excellent formability. Further, due to such viscosity, the adhesive resin can further increase vibration-damping, sound-absorbing, heat-insulating effects.

Preferably, the surface plate is formed to have a thickness from 0.1 mm to 0.4 mm, the backing plate 12 is formed to have a thickness from 0.4 mm to 1.2 mm, and the adhesive resin 13 bonding the surface plate 11 with the backing plate 12 is formed to have a thickness from 0.02 mm to 0.1 mm. In order to solve the problem that the cost of production sharply increases in the case of using the conventional single steel sheet made of relatively expensive stainless steel, etc., the present invention is technically characterized in that the surface plate 11, which requires excellent corrosion resistance and workability due to the exposure to the outside, is formed thin, and simultaneously the backing plate 12 backing the surface plate inside is thickly formed of the relatively inexpensive steel sheet, and is bonded with the surface plate 11 using the adhesive resin 13 having excellent sound and vibration damping characteristics. Preferably, the surface plate 11 is formed to have a thickness from 0.1 mm to 0.4 mm. When the surface plate 11 has a thickness of 0.1 mm or less, it is too thin, and thus itself is warped or torn by impact applied from the outside. In contrast, when the surface plate 11 has a thickness of 0.4 mm or more, the effect of reducing the cost of production is relatively lowered. Meanwhile, the adhesive resin 13 is formed to have a thickness from 0.02 mm to 0.1 mm. When the adhesive resin 13 has a thickness of 0.02 mm or less, the sound-absorbing, vibration-damping, and heat-insulating characteristics are lowered. In contrast, when the adhesive resin 13 has a thickness of 0.1 mm or more, the adhesive resin layer cannot maintain uniform viscosity in the thickness direction.

More preferably, the backing plate 12 may be provided with an anti-corrosion coating layer on a lower surface thereof. This is because the backing plate 12 uses the relatively inexpensive ordinary steel sheet unlike the surface plate, and thus has a possibility of generating internal corrosion when used for a long time.

Method of Forming Sink Bowl Using Bonded Plate through Multi-stage Pressing

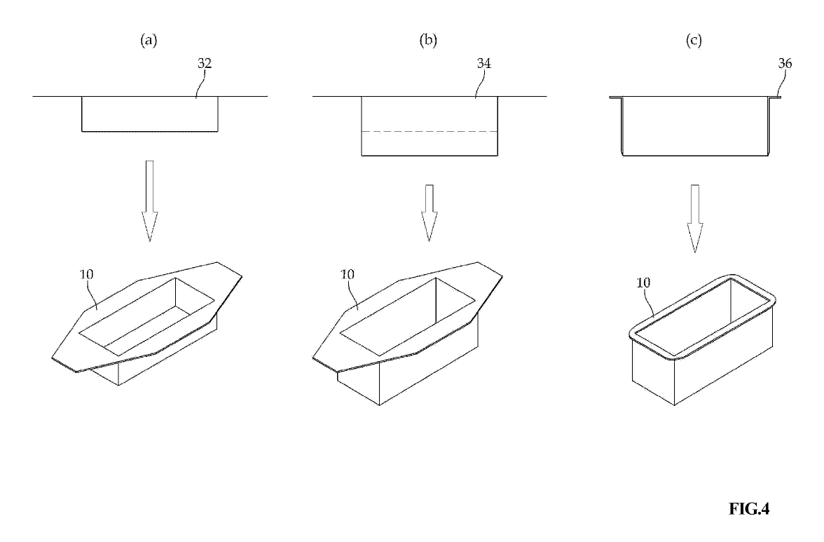

FIG. 3 is a perspective view illustrating a sink bowl 20 produced using a bonded plate according to the present invention, and FIG. 4 is a conceptual view taken illustrating a method of forming a sink bowl using a bonded plate through pressing according to another embodiment of the present invention.

The method of forming the sink bowl 20 of FIG. 3 using the above-described bonded plate with reference to FIG. 4 will be described below.

The method of forming a sink bowl 20 using a bonded plate 10 according to another embodiment of the present invention includes preparing the bonded plate 10 by bonding a surface plate 11 and a backing with an adhesive resin 13 having viscosity from 2500 cps to 4500 cps; modeling the sink bowl in a desired shape and sequentially pressing the bonded plate 10 using a first die 32 capable of pressing the modeled sink bowl up to a depth between ½ and ⅔ from the top of the sink bowl and a second die 34 capable of pressing the pressed sink bowl up to the bottom of the modeled sink bowl; and cutting off or trimming surrounding unnecessary portions of the pressed sink bowl using a trimming die 36.

As described above, the reason of continuously pressing the sink bowl 20 using the first and second dies 32 and 34 is because the bonded plate is torn when pressed once. For this reason, the sink bowl 20 is formed in a desired shape by multi-stage pressing, for instance, two-stage pressing.

In particular, because the bonded plate 10 is made by bonding homogeneous and heterogeneous steel sheets using the adhesive resin 13, the steel sheets of the bonded plate 10 can be mutually pushed and separated relative to each other by force applied in one direction when pressed. Thus, the homogeneous and heterogeneous steel sheets are bonded with each other using the adhesive resin 13 having a predetermined viscosity, so that they can have excellent shear resistance to minimize the separation. Furthermore, the adhesive resin 13 used for the present invention has the viscosity from 2500 cps to 4500 cps, so that, although the steel sheets of the bonded plate 10 are pushed against each other, it can still maintain adhesive force in the pushed state. Further, in the trimming process, the unnecessary portion of the edge of the bonded plate is cut off. Finally, the bottom and sidewall of the sink bowl 20 are provided with a drainage hole for draining the water and an overflow hole for preventing the sink bowl from overflowing. Thereby, a final product is produced.

As is apparent from the above description, the present invention has the following effects. First, the bonded plate 10, which has the surface plate 11 bonded with the backing plate 12 using the adhesive resin 13, is used, so that the adhesive resin layer of the bonded plate 10 can have sound-absorbing, vibration-damping and dew-condensation-preventing functions. Further, the sink bowl 20 is produced using the bonded plate 10, so that it can remarkably reduce the cost of production, can secure formability equal to that of the conventional sink bowl, and can produce excellent sound-absorbing, vibration-damping, and dew-condensation-preventing effects.

Second, the bonded plate 10 maintains the adhesive resin 13 thereof to have a predetermined viscosity, so that, when the bonded plate 10 is formed, the adhesive resin layer itself is not fractured, and can increase sound-absorbing, vibration-damping, and heat-insulating characteristics due to such viscosity.

Third, in order to solve the problem that the cost of production sharply increases in the case of using the conventional single steel sheet made of relatively expensive stainless steel, etc., the bonded plate 10 is produced in such a manner that the surface plate 11 exposed to the outside is formed thin using the steel sheet having excellent corrosion resistance and workability, and simultaneously the backing plate 12 backing the surface plate 11 inside is formed from the relatively inexpensive steel sheet and is bonded with the surface plate 11 using the adhesive resin 13 having excellent sound-absorbing, vibration-damping and heat-insulating characteristics, so that it can remarkably reduce the cost of production.

Although the exemplary embodiments of the present invention have been described for illustrative purposes, those skilled in the art will appreciate that various modifications, additions and substitutions are possible, without departing from the scope and spirit of the invention as defined in the accompanying claims.

1. A bonded plate for a sink bowl, comprising:
a surface plate;
a backing plate backing the surface plate; and
an adhesive resin interposed between the surface plate and the backing plate and bonding the surface plate and the backing plate with each other,
wherein the adhesive resin has a thickness from about 0.02 mm to about 0.1 mm,
whereby improved excellent sound-absorbing, vibration-damping and heat-insulating characteristics are achievable from the bonded plate.

2. The bonded plate as set forth in claim 1, wherein the surface plate has a thickness from about 0.1 mm to about 0.4 mm, and wherein the backing plate has a thickness from about 0.4 mm to about 1.2 mm.

3. The bonded plate as set forth in claim 2, wherein the surface plate is formed of stainless steel, which has excellent corrosion resistance and workability, and
wherein the backing plate is formed from one selected from the group consisting of a galvanized steel sheet, a stainless steel sheet, an aluminum sheet, a polyester painted steel sheet, a cold rolled steel sheet, and a pickled and oiled steel sheet.

4. The bonded plate as set forth in claim 2, wherein each of the surface plate and the backing plate has bending rigidity from about 10.5 Nm to about 16.5 Nm.

5. The bonded plate as set forth in claim 2, wherein the backing plate further includes an anti-corrosion coating layer on a lower surface thereof.

6. The bonded plate as set forth in claim 2, wherein the adhesive resin has viscosity from about 2500 cps to about 4500 cps.

7. The bonded plate as set forth in claim 1, wherein the surface plate is formed of stainless steel, which has excellent corrosion resistance and workability, and
wherein the backing plate is formed from one selected from the group consisting of a galvanized steel sheet, a stainless steel sheet, an aluminum sheet, a polyester painted steel sheet, a cold rolled steel sheet, and a pickled and oiled steel sheet.

8 . The bonded plate as set forth in claim 1, wherein each of the surface plate and the backing plate has bending rigidity from about 10.5 Nm to about 16.5 Nm.

9. The bonded plate as set forth in claim 1, wherein the backing plate further includes an anti-corrosion coating layer on a lower surface thereof.

10. The bonded plate as set forth in claim 1, wherein the adhesive resin has viscosity from about 2500 cps to about 4500 cps.

11. A method of forming a sink bowl using a bonded plate, the method comprising the steps of:
preparing the bonded plate bonding a surface plate and a backing with an adhesive resin having viscosity from 2500 cps to 4500 cps, so that the bonded plate has excellent sound-absorbing, vibration-damping and heat-insulating characteristics through multi-stage pressing;
modeling the sink bowl in a desired shape and sequentially pressing the bonded plate using a first die capable of pressing the modeled sink bowl up to a depth between ½ and ⅔ from the top of the sink bowl and a second die capable of pressing the pressed sink bowl up to a bottom of the modeled sink bowl; and
cutting off surrounding unnecessary portions of the pressed sink bowl using a trimming die.

12. The method as set forth in claim 11, wherein the bonded plate includes the surface plate, the backing plate backing the surface plate, and the adhesive resin interposed between the surface plate and the backing plate and bonding the surface plate and the backing plate with each other,
wherein the adhesive resin has a thickness from about 0.02 mm to about 0.1 mm,
wherein the surface plate has a thickness from about 0.1 mm to about 0.4 mm, and
wherein the backing plate has a thickness from about 0.4 mm to about 1.2 mm.

13. The method as set forth in claim 12, wherein the surface plate is formed of stainless steel, which has excellent corrosion resistance and workability,
wherein the backing plate is formed from any one selected from a galvanized steel sheet, a stainless steel sheet, an aluminum sheet, a polyester painted steel sheet, a cold rolled steel sheet, and a pickled and oiled steel sheet, and
wherein each of the surface plate and the backing plate has bending rigidity from about 10.5 Nm to about 16.5 Nm.

14. The method as set forth in claim 11, wherein the surface plate is formed of stainless steel, which has excellent corrosion resistance and workability,
wherein the backing plate is formed from any one selected from a galvanized steel sheet, a stainless steel sheet, an aluminum sheet, a polyester painted steel sheet, a cold rolled steel sheet, and a pickled and oiled steel sheet, and
wherein each of the surface plate and the backing plate has bending rigidity from about 10.5 Nm to about 16.5 Nm.
